(19) United States
(12) Patent Application Publication
(10) Pub. No.: US 2025/0247796 A1
(43) Pub. Date: Jul. 31, 2025

(54) DIRECTIONAL ELECTRO-MAGNETIC FIELD (EMF) AVERAGE POWER CONTROL

(71) Applicant: Telefonaktiebolaget LM Ericsson (publ), Stockholm (SE)

(72) Inventors: Amr EL-KEYI, Kanata (CA); Torbjörn WIGREN, Uppsala (SE); Shiguang GUO, Kanata (CA)

(21) Appl. No.: 19/111,133

(22) PCT Filed: Sep. 28, 2022
(86) PCT No.: PCT/IB2022/059255

§ 371 Date: Mar. 12, 2025

(51) Int. Cl. H04W 52/24; H04B 7/0426; H04W 52/14; H04W 52/22; H04W 52/36

(52) U.S. Cl. CPC H04W 52/241; H04B 7/043; H04W 52/143; H04W 52/225; H04W 52/245; H04W 52/367

(57) ABSTRACT

A method, system and apparatus are disclosed. A network node is provided. The network node includes processing circuitry configured to estimate a first signal quality metric associated with the first wireless device, determine a first directional electromagnetic field, EMF, limiting mechanism for transmission to the first wireless device based on the first signal quality metric where the first directional EMF limiting mechanism is different from another directional EMF limiting mechanism used for transmission to at least one other wireless device in the cell, and cause transmission to the first wireless device using the first directional EMF limiting mechanism.

### TECHNICAL FIELD

The present disclosure relates to wireless communications, and in particular, to directional electro-magnetic field (EMF) average power control such as, for example, via power backoff and/or bandwidth limitation.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

Radio frequency (RF) exposure limitations aim at ensuring that human exposure to RF energy is kept within safe limits. This increases the deployment challenges, which is why operators are requesting functionality for reduction of reduction of exclusion zones, while strictly maintaining compliance with RF exposure regulations. RF exposure limitations are expressed as the average power density over a specified time interval T. These limitations correspond to a constraint that ensures that the transmitted average power per direction over the time interval T is below a specific limit. This power averaging opens a possibility for the requested reduction of exclusion zones. Given a distance, the power density limit can be transformed to a corresponding power limit, for the average total transmitted power. Thus, the momentary power can be significantly higher than the limit during shorter times than T, however the transmitted average power must then be guaranteed to be below the limit, typically obtained from the calculation of a reduced exclusion zone.

Beamforming is a technique by which an array of transmit antennas can be utilized to focus the radiated energy in a specific target direction and/or reduce the radiated energy in other directions. Instead of simply broadcasting the transmitted signals in all directions, the antenna arrays that use beamforming, determine a direction of interest and form a stronger beam in this direction. With Multi-antenna transmission capability at the network node, the network node can employ beamforming on the downlink transmitted signal resulting in non-isotropic RF radiations. Since the users are typically spatially distributed, the spatial direction corresponding to the maximum transmitted momentary power can be different from one transmission time interval (TTI) to the next. Taking this spatial variation of the momentary power into account opens the possibility for an additional reduction of RF exposure exclusion zone.

Existing directional Electro-Magnetic Field (EMF) use a cell-wide EMF limit enforcement strategy that restricts the number of allowed physical resource blocks (PRBs) for downlink scheduling. As a result, this can result in significant reduction of downlink throughput especially when there is a large number of users in good radio conditions. Existing systems have considered joint power downscaling and PRB limitation to solve this problem by scaling down the transmitted power per PRB when the triggered EMF limit threshold falls below a given threshold which allows upscaling of the number of PRBs allowed for downlink transmission. However, existing techniques also use a cell-wide limitation approach which can cause significant reduction in the received signal power at cell-edge users leading to reduction in cell coverage.

### SUMMARY

Some embodiments advantageously provide methods, systems, and apparatuses for directional EMF average power control such as, for example, via power backoff and bandwidth limitation.

In some embodiments of the present disclosure, multiple spatial controllers are utilized, where each controller is associated with a prespecified EMF spatial sector. After each downlink scheduling instant, the downlink allocation and relevant link adaptation information are used to update the state of the spatial controllers yielding the EMF limit for each spatial sector. Instead of using a cell-wide limitation solution, the EMF limit for each scheduling request may be calculated using the EMF limits for different spatial sectors and the precoder that will be utilized in transmitting the scheduling request. This limit may be used to control the power spectral density of the transmitter, i.e., the power per resource block, when the downlink scheduling request is served. The power limit information is also used by the link adaptation algorithm to determine the information carrying capacity (ICC) of the codeword and select the modulation and coding scheme (MCS) and transport block size (TBS) during link adaptation computations for this downlink scheduling request.

In some embodiments of the present disclosure, in order to avoid degradation in cell edge throughput, the network node and/or wireless device fall back to a bandwidth limiting EMF enforcement strategy when a cell-edge user is expected to be scheduled in the next transmission interval. In particular, a list of candidate users for scheduling in the next transmission interval may be constructed based on the available downlink bandwidth, the priorities of the users in the scheduling queue, and/or the downlink buffer size and ICC of each user. The estimated SINR of each candidate user may then be compared against a threshold, and if the SINR of any candidate user is below the threshold, the bandwidth limiting strategy may be used for EMF enforcement, e.g., instead of controlling the power spectral density of the transmitter.

Embodiments of the present disclosure may provide one or more of the following:

1. A directional EMF limiting mechanism that employs multiple spatial controllers each associated with a spatial EMF sector. The EMF limiting mechanism may calculate the EMF limit for each scheduling request using the beamforming gain of the precoder that will be utilized in serving the request and/or the latest EMF limits of different spatial sectors.

2. A reduced-complexity beamforming gain calculation technique that divides the Azimuth/Elevation dimensions into a finite set of EMF sectors, where one or more spatial DFT beams may be mapped to each EMF sector.

3. The EMF limit for different requests may be enforced by controlling the power spectral density of the transmitter, i.e., the power per resource block, when the downlink scheduling request is served. The power limit information may also be used by the link adaptation technique to determine MCS and/or TBS serving the scheduling requests.

4. Falling back to a bandwidth limiting EMF enforcement strategy when a cell-edge user is expected to be scheduled in the next transmission interval.

In some embodiments of the present disclosure, using a cell-wide limitation mechanism to enforce the EMF limit constraints may be avoided. As a result, the EMF limit for different scheduling requests may be calculated and/or enforced based on the downlink precoding information for the scheduling request(s). This may improve downlink cell throughput, e.g., compared to existing techniques that use a cell-wide power per PRB scaling and bandwidth limitation, e.g., as illustrated by system-level numerical simulations. In addition, embodiments of the present disclosure may use different EMF thresholds for different spatial sectors, e.g., where directional radiation information is used in computing and enforcing the EMF limit of different scheduling requests. Embodiments of the present disclosure may also improve on existing systems by offering protection to cell-edge users, e.g., by falling back to a cell-wide bandwidth limitation EMF enforcement strategy when a cell edge user is expected to be scheduled.

According to one aspect of the present disclosure, a network node configured for directional EMF average power control is provided. The network node is configured to estimate a first signal quality metric associated with a first wireless device. The network node is configured to determine a first directional electromagnetic field, EMF, limiting mechanism for transmission to the first wireless device based on the first signal quality metric, where the first directional EMF limiting mechanism is different from another directional EMF limiting mechanism used for transmission to at least one other wireless device in the cell. The network node is configured to cause transmission to the first wireless device using the first directional EMF limiting mechanism.

In one or more embodiments of this aspect, the network node is further configured to determine that the first wireless device is not located at an edge of the cell based on the estimated first signal quality metric, where the determining of the first directional EMF limiting mechanism is further based on the determination that the first wireless device is not located at the edge of the cell, where the first directional EMF limiting mechanism includes a first power spectral density limit. In one or more embodiments of this aspect, the network node is further configured to determine a second directional EMF limiting mechanism for a second wireless device in the cell based on the determination that the first wireless device is not located at the edge of the cell, where the second directional EMF limiting mechanism includes a second power spectral density limit used for transmission to the second wireless device different from the first power spectral density limit. In one or more embodiments of this aspect, the network node is further configured to determine that a third wireless device is located at an edge of the cell based on an estimated third signal quality metric for the third wireless device, and to determine a third directional EMF limiting mechanism including a third limit on an available bandwidth during transmission to the third wireless device.

In one or more embodiments of this aspect, the first directional EMF limiting mechanism is one of a first power spectral density limit based on the first signal quality metric being above a first threshold, and a first bandwidth limit based on the first signal quality metric being below the first threshold. In one or more embodiments of this aspect, the first signal quality metric includes at least one of, an information carrying capacity, ICC, a signal to interference and noise ratio, SINR, a signal to noise ratio, SNR, a reference signal received power, RSRP, a reference signal received quality, RSRQ, and a received signal strength indicator, RSSI. In one or more embodiments of this aspect, the network node is further configured to receive a first scheduling request from the first wireless device, where the determining of the first directional EMF limiting mechanism is further based at least on the power spectral density and bandwidth required for serving the first scheduling request. In one or more embodiments of this aspect, the network node is further configured to determine a first beamforming gain associated with a precoder used for transmission to the first wireless device based on the first signal quality metric and the first scheduling request. In one or more embodiments of this aspect, the determining of the first directional EMF limiting mechanism is further based on the first beamforming gain. In one or more embodiments of this aspect, a first power spectral density limit is different from at least one other power spectral density limit of at least one other directional EMF limiting mechanism used for transmission to at least one other wireless device located in a second sector in the cell different from a first sector.

According to another aspect of the present disclosure, a method implemented in a network node configured for directional EMF average power control is provided. A first signal quality metric associated with a first wireless device is estimated. A first directional electromagnetic field, EMF, limiting mechanism for transmission to the first wireless device is determined based on the first signal quality metric, where the first directional EMF limiting mechanism is different from another directional EMF limiting mechanism used for transmission to at least one other wireless device in the cell. A transmission to the first wireless device is caused using the first directional EMF limiting mechanism.

In one or more embodiments of this aspect, the first wireless device is determined to be not located at an edge of the cell based on the estimated first signal quality metric, where the determining of the first directional EMF limiting mechanism is further based on the determination that the first wireless device is not located at the edge of the cell, where the first directional EMF limiting mechanism includes a first power spectral density limit. In one or more embodiments of this aspect, a second directional EMF limiting mechanism for a second wireless device in the cell is determined based on the determination that the first wireless device is not located at the edge of the cell, where the second directional EMF limiting mechanism includes a second power spectral density limit used for transmission to the second wireless device different from the first power spectral density limit. In one or more embodiments of this aspect, a third wireless device is determined to be located at an edge of the cell based on an estimated third signal quality metric for the third wireless device, and to determine a third directional EMF limiting mechanism including a third limit on an available bandwidth during transmission to the third wireless device. In one or more embodiments of this aspect, the first directional EMF limiting mechanism is one of a first power spectral density limit based on the first signal quality metric being above a first threshold, and a first bandwidth limit based on the first signal quality metric being below the first threshold.

In one or more embodiments of this aspect, the first signal quality metric includes at least one of, an information carrying capacity, ICC, a signal to interference and noise ratio, SINR, a signal to noise ratio, SNR, a reference signal received power, RSRP, a reference signal received quality, RSRQ, and a received signal strength indicator, RSSI. In one or more embodiments of this aspect, a first scheduling request from the first wireless device is received, where the determining of the first directional EMF limiting mechanism is further based at least on the power spectral density and bandwidth required for serving the first scheduling request. In one or more embodiments of this aspect, a first beamforming gain associated with a precoder used for transmission to the first wireless device is determined based on the first signal quality metric and the first scheduling request. In one or more embodiments of this aspect, the determining of the first directional EMF limiting mechanism is further based on the first beamforming gain. In one or more embodiments of this aspect, a first power spectral density limit is different from at least one other power spectral density limit of at least one other directional EMF limiting mechanism used for transmission to at least one other wireless device located in a second sector in the cell different from a first sector.

According to another aspect of the present disclosure, a non-transitory computer readable storage medium storing a computer program including instructions for causing processing circuitry to at least one of control and perform a method for directional EMF average power control is provided. A first signal quality metric associated with a first wireless device is estimated. A first directional electromagnetic field, EMF, limiting mechanism for transmission to the first wireless device is determined based on the first signal quality metric, where the first directional EMF limiting mechanism is different from another directional EMF limiting mechanism used for transmission to at least one other wireless device in the cell. A transmission to the first wireless device is caused using the first directional EMF limiting mechanism.

In one or more embodiments of this aspect, the first wireless device is determined to be not located at an edge of the cell based on the estimated first signal quality metric, where the determining of the first directional EMF limiting mechanism is further based on the determination that the first wireless device is not located at the edge of the cell, where the first directional EMF limiting mechanism includes a first power spectral density limit.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for directional EMF average power control according to some embodiments of the present disclosure;

FIG. 8 is a block diagram of an EMF power limit system according to some embodiments of the present disclosure;

FIG. 9 is a block diagram of a sub-portion of the EMF power limit system of FIG. 8 according to some embodiments of the present disclosure;

FIG. 10 is a diagram illustrating an example array configuration according to some embodiments of the present disclosure;

FIG. 11 is a graph illustrating beampatterns of different spatial DFT beams for an 8-element array according to some embodiments of the present disclosure;

FIG. 12 is a flowchart illustrating an example bandwidth limit fallback algorithm according to some embodiments of the present disclosure;

FIG. 13 is a flowchart illustrating an example algorithm for determining whether a cell-edge wireless device will be scheduled according to some embodiments of the present disclosure;

FIG. 14 is a graph illustrating ICC per resource element versus SINR for different limiting solutions and EMF thresholds according to some embodiments of the present disclosure;

FIG. 15 is a graph illustrating cell throughput versus number of EMF spatial sectors according to some embodiments of the present disclosure; and

FIG. 16 is a graph illustrating downlink cell throughput versus additional downlink interference according to some embodiments of the present disclosure.

### DETAILED DESCRIPTION

Before describing in detail example embodiments, it is noted that the embodiments reside primarily in combinations of apparatus components and processing steps related to directional EMF average power control. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for directional EMF average power control.

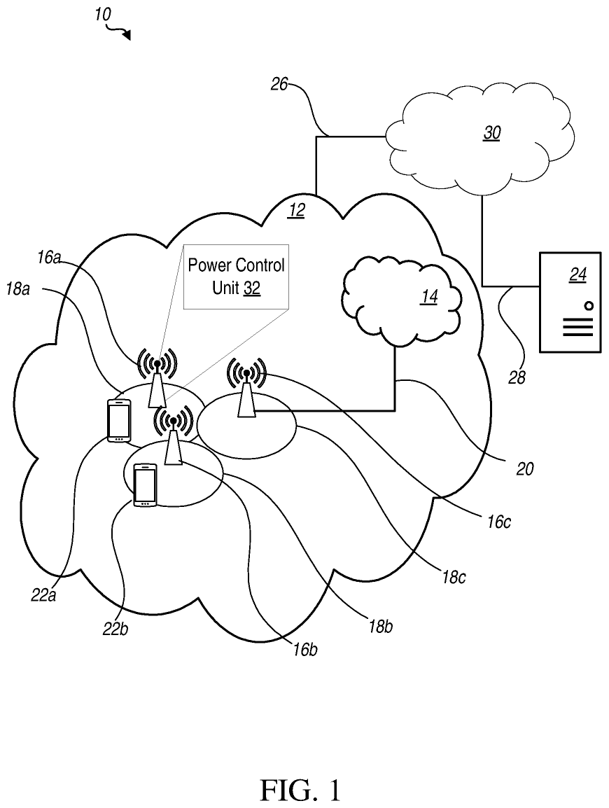

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a power control unit 32 which is configured for directional EMF average power control.

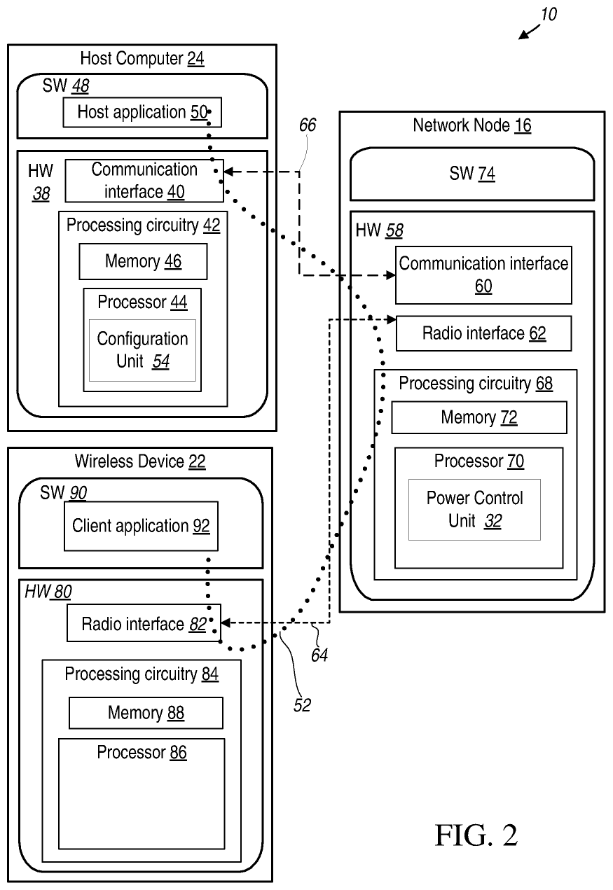

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a configuration unit 54 configured to enable the service provider to observe/monitor/control/transmit to/receive from/etc. the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include power control unit 32 configured for directional EMF average power control.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as power control unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

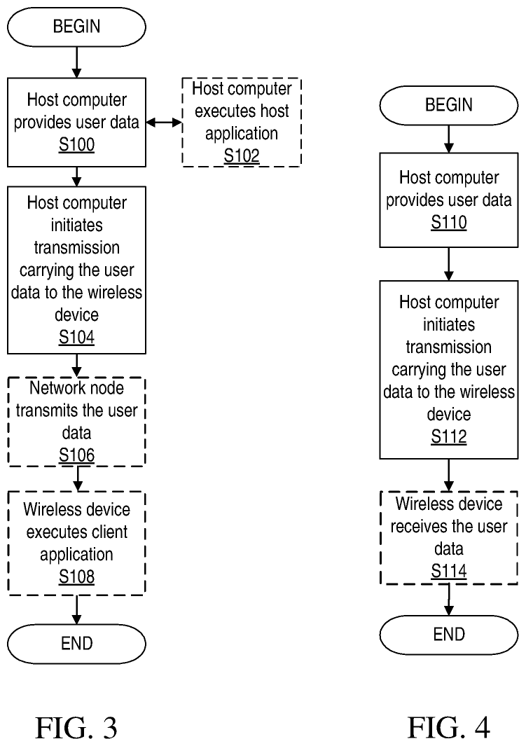

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

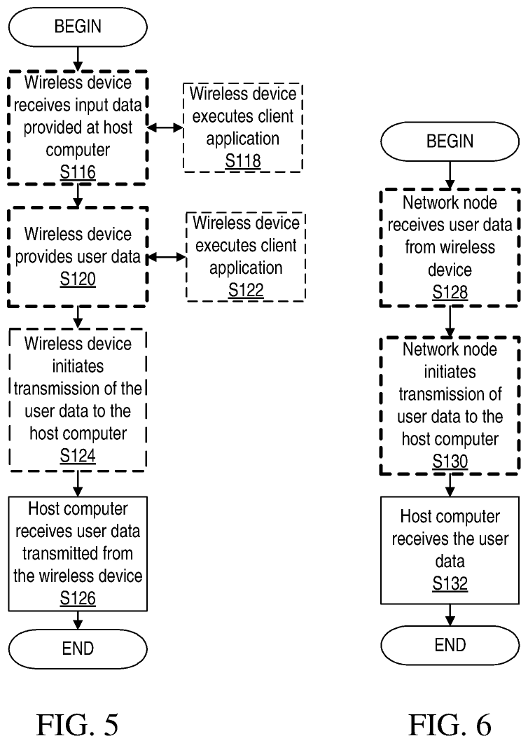

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

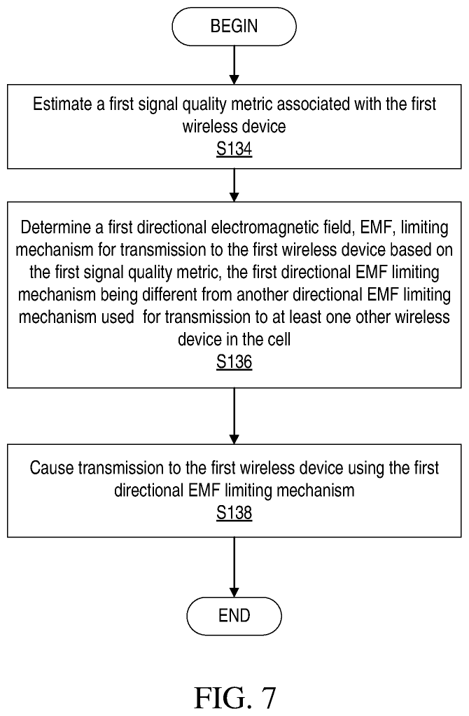

FIG. 7 is a flowchart of an example process in a network node 16 for configured for directional EMF average power control. One or more blocks described herein may be performed by one or more elements of network node 16 such as by one or more of processing circuitry 68 (including the power control unit 32), processor 70, radio interface 62 and/or communication interface 60. Network node 16 is configured to estimate (Block S134) a first signal quality metric associated with the first wireless device 22. Network node 16 is configured to determine (Block S136) a first directional electromagnetic field, EMF, limiting mechanism for transmission to the first wireless device 22 based on the first signal quality metric, where the first directional EMF limiting mechanism is different from another directional EMF limiting mechanism used for transmission to at least one other wireless device in the cell. Network node 16 is configured to cause transmission (Block S138) to the first wireless device 22 using the first directional EMF limiting mechanism.

In some embodiments, network node 16 is further configured to determine that the first wireless device 22 is not located at an edge of the cell 18 based on the estimated first signal quality metric, where the determining of the first directional EMF limiting mechanism is further based on the determination that the first wireless device is not located at the edge of the cell 18, where the first directional EMF limiting mechanism includes a first power spectral density limit.

In some embodiments, network node 16 is further configured to determine a second directional EMF limiting mechanism for a second wireless device in the cell 18 based on the determination that the first wireless device 22 is not located at the edge of the cell 18, where the second directional EMF limiting mechanism includes a second power spectral density limit used for transmission to the second wireless device 22 different from the first power spectral density limit.

In some embodiments, network node 16 is further configured to determine that a third wireless device 22 is located at an edge of the cell 18 based on an estimated third signal quality metric for the third wireless device 22, and to determine a third directional EMF limiting mechanism including a third limit on an available bandwidth during transmission to the third wireless device 22.

In some embodiments, first directional EMF limiting mechanism is one of a first power spectral density limit based on the first signal quality metric being above a first threshold, and a first bandwidth limit based on the first signal quality metric being below the first threshold.

In some embodiments, the first signal quality metric includes at least one of, an information carrying capacity, ICC, a signal to interference and noise ratio, SINR, a signal to noise ratio, SNR, a reference signal received power, RSRP, a reference signal received quality, RSRQ, and a received signal strength indicator, RSSI.

In some embodiments, network node 16 is further configured to receive a first scheduling request from the first wireless device 22, where the determining of the first directional EMF limiting mechanism is further based at least on the power spectral density and bandwidth required for serving the first scheduling request.

In some embodiments, network node 16 is further configured to determine a first beamforming gain associated with a precoder used for transmission to the first wireless device 22 based on the first signal quality metric and the first scheduling request. In some embodiments, the determining of the first directional EMF limiting mechanism is further based on the first beamforming gain. In some embodiments, a first power spectral density limit is different from at least one other power spectral density limit of at least one other directional EMF limiting mechanism used for transmission to at least one other wireless device 22 located in a second sector in the cell 18 different from a first sector.

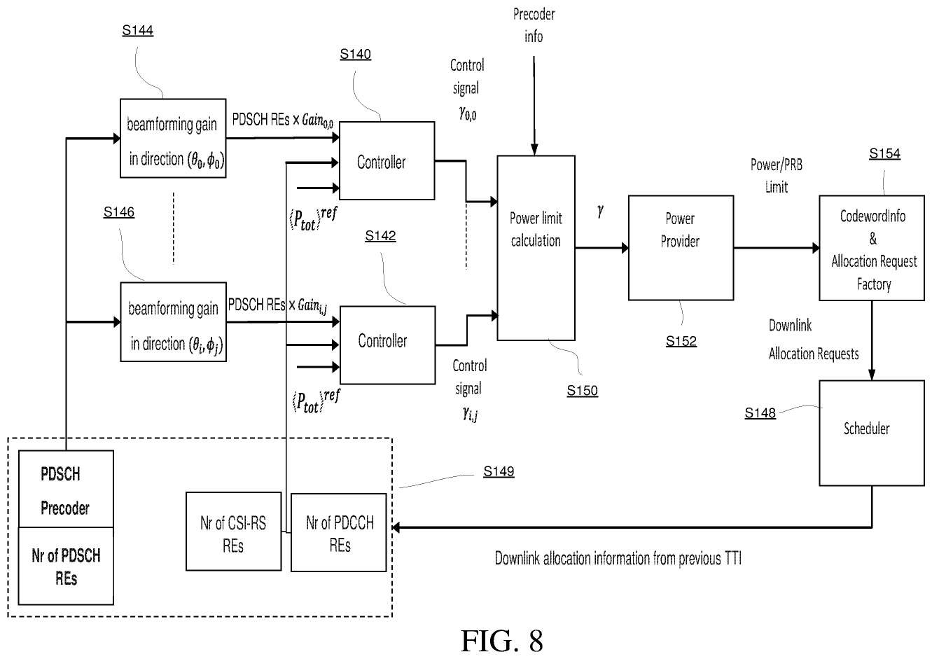

FIG. 8 shows a block diagram of some example implementations (e.g., in processing circuitry 68) of the per-direction EMF control algorithm, according to some embodiments of the present disclosure. In the example of FIG. 8, the two-dimensional azimuth/elevation space is divided into several spatial EMF sectors {(i, j)} i,j where i denotes the EMF spatial index in the horizontal dimension and j denotes the EMF spatial index in the vertical dimension. One or more spatial controllers (e.g., as implemented in processing circuitry 68) may be utilized. Multiple spatial controllers (as illustrated at Blocks S140, S142) for example may be employed, where one or more such controllers (e.g., each and every controller, a subset of the controllers, etc.) may be associated with a prespecified EMF spatial sector (i, j). Each spatial controller may utilize a beamforming gain calculation block (Blocks S144, S146) that computes the beamforming gain due to using a given beamforming vector in the corresponding spatial EMF sector. After a downlink scheduling instant (Block S148), the downlink allocation and relevant link adaptation information may be used (Block S149) to update the state of the spatial controllers (Blocks S140, S142). The downlink allocation information may include the number of resource elements allocated to different downlink channels, e.g., the physical downlink shared channel (PDSCH), physical downlink control channel (PDCCH) in 4G/5G systems, etc., as well as the number of resource elements used to transmit the reference signals. The link adaptation information may include the number of layers used for each wireless device 22, the beamforming vectors used to transmit different physical channels, as well as the power share of each layer.

After updating the state of each feedback controller, the thresholds of the spatial controllers may be used to compute the EMF power limit for the downlink scheduling requests that will be processed in the next TTI. The power limit information γ(q) for a scheduling request associated with user q (e.g., a wireless device 22) may be calculated (Block S150) using the controller thresholds {γ_{i,j}} and the precoder that will be utilized in transmitting the scheduling request for user q (wireless device 22). These calculations may be performed by processing circuitry 68, for example. The power limit γ(q) may be used to control (Block S152) the power spectral density of the transmitter, i.e., the power per physical resource block (PRB) when transmitting to user q (wireless device 22). The power limit information may also be used by the link adaptation calculation (e.g., by processing circuitry 68) to determine (Block S154) the information carrying capacity (ICC) of the codeword and select the modulation and coding scheme (MCS) and transport block size (TBS) during link adaptation computations for this user (wireless device 22).

### Integrating Controller

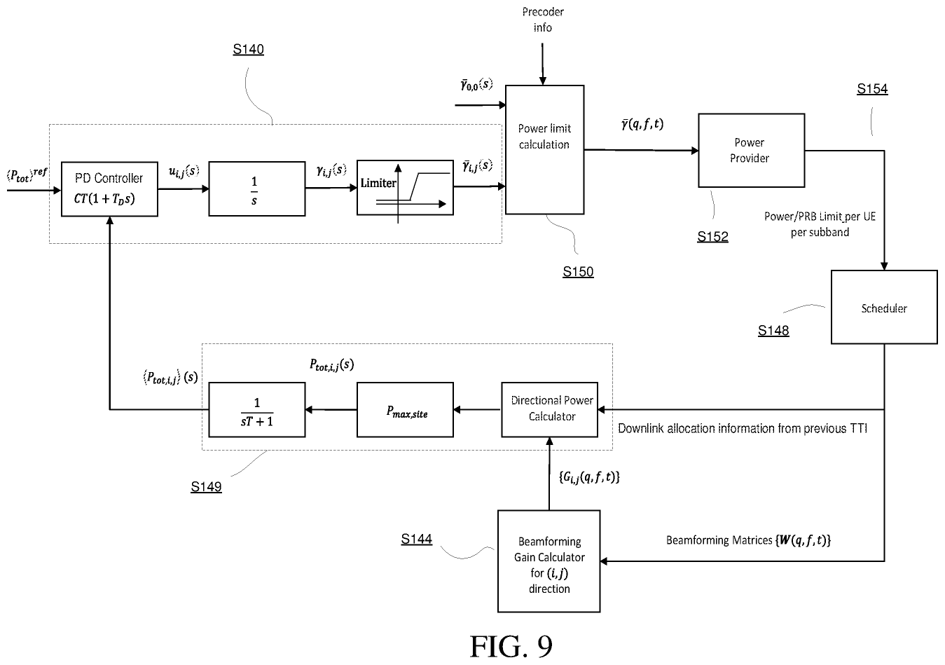

FIG. 9 illustrates a block diagram of an example embodiment of the integrating controller (e.g., of processing circuitry 68) associated with the EMF spatial sector (i, j) in the Laplace transform domain. Integrating control may refer to computing the control signal from the integral of the control error. The magnitude of the control signal may increase if there is a remaining control error with constant sign. If the dynamics of the system are linear, then in some cases, the only way a steady state solution may be achieved is when the integrating controller steers the control error to zero, in which case:

[symbol]

(Pₜₒₜ) [symbol] ^{ref}= [symbol] (P_{tot,i,j} [symbol] (s).

This property holds when the control system is stable, irrespective of the dynamics of the un-controlled system. On the negative side, integrating control may reduce stability margins, which is the reason why proportional-integrator (PI) control applies a mix of proportional and integrating control, e.g., using a dynamic controller, for example, implemented processing circuitry 68. Note that the average power controller in FIG. 9 may make use of the realization of PI control (e.g., in processing circuitry 68) that factors out an integrator (1/s). As a result, the dynamics of the PI-controller may resemble a proportional term and a differentiating term CT(1+T_{D}s). Hence, in some embodiments of the present disclosure, applied average power back-off control is proportional-derivative (PD) control together with an integrating power limiting threshold.

In order to obtain a smooth behavior of the dynamic resource threshold applied in the scheduler to limit the output power per PRB, it may need to be rate controlled. This means that the control signal commands/causes adjustments to the limiter (e.g., of processing circuitry 68), making it increase or decrease. The dynamics of the actuator mechanism (dynamic resource threshold) may therefore be determined according to:
γ_{i,j}(t)=u_{i,j}(t), where γ_{i,j}(t) is the dynamic threshold for EMF sector (i, j) and μ_{i,j}(t) is the corresponding control signal at time t. This is in line with the factored PI control structure of FIG. 9. The dynamic resource threshold is decoupled from the scheduler algorithm, it expresses a fractional limitation of the scheduler not to use more than a fraction γ_{i,j}(t) of its total power per PRB if the total transmission power is directed towards the spatial sector (i, j). The scheduler (which may be implemented in processing circuitry 68) may then limit the power per PRB it uses or limit any other quantity that correlates or correlates well with the momentary output power.

The maximum value of γ_{i,j}(t) may be smaller than 1.0 since it is to express a fraction of the maximum amount of scheduler resources. There is also a need to limit its lower value, to avoid that the dynamic feedback control mechanism reduces it to an unphysical value below 0.0. The following scheduler threshold limitation may therefore be applied at each time according to:

$${γ}_{low} \leq {γ}_{i , j} ( t ) \leq 1.$$

where γ̅_{i,j}(t) denotes the scheduler limitation after lower and upper limitation.

In FIG. 9, P_{max,site} denotes the maximal total power of the site (site is here may be interpreted as cell 18 and/or sector and/or carrier), 1/(sT+1) represents an autoregressive simplified model of the averaging, and [symbol] P_{tot,i,j} [symbol] (s) denotes the averaged total power. Note that some or all quantities here may be expressed in the Laplace transform domain, which may be allowed since the feedback control mechanism design may be performed with constraints inactive. The momentary power described above is denoted Pₜₒₜ(s). It may then be assumed that the controller block (e.g., as implemented in processing circuitry 68) is given by:

$${u}_{i , j} ( s ) = CT ( 1 + {T}_{D} s ) ( {〈 {P}_{tot} 〉}^{ref} - 〈 {P}_{tot , i , j} 〉 ( s ) )$$

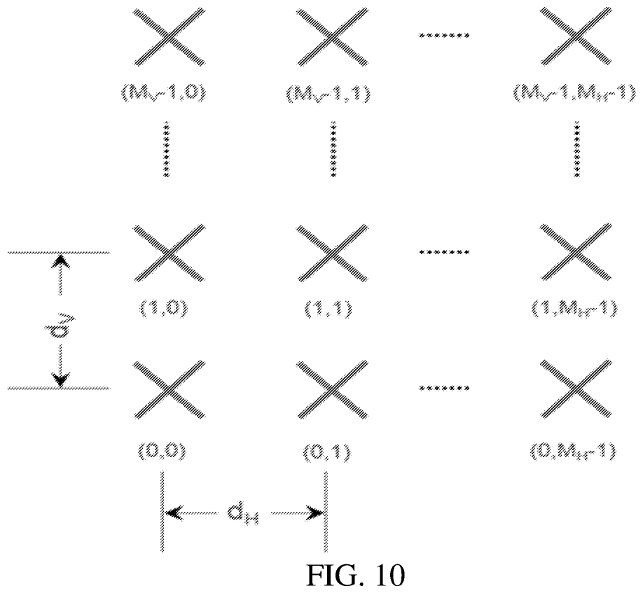

This controller may be of PD type in some embodiments. C denotes the proportional gain, and T_{D} the differentiation time. Following standard procedures of automatic control, the poles of the closed loop system of FIG. 10 may be given by the following second order equation

$${s}^{2} + ( 1 / T + {P}_{max , site} {CT}_{D} ) s + {P}_{max , site} C = 0$$

These poles govern the closed loop dynamics of the feedback control mechanism, the actuator mechanism, and the averaged power. In order to determine the proportional gain and the differentiation time, a closed loop polynomial with desired poles in −α₁ and −α₂ is specified as

$${s}^{2} + ( {α}_{1} + {α}_{2} ) s + {α}_{1} {α}_{2} = 0$$

An identification of coefficients and solution of the resulting system of equations reveal that the proportional gain and differentiation time may be selected as

$$C = \frac{{α}_{1} {α}_{2}}{{P}_{max , site}} ,$$

$${T}_{D} = \frac{{α}_{1} + {α}_{2} - \frac{1}{T}}{{α}_{1} {α}_{2}} .$$

A reason for this choice is that a system with two negative real poles can be expected to be well damped, which is a result of a significant differentiation action. Since differentiation action may be needed for fast back-off close to the determined threshold, this may be a beneficial design choice, for at least some embodiments.

### Beamforming Gain Calculation

Referring back to FIG. 8, each spatial controller may be associated with a beamforming calculator. The function of the beamforming gain calculation block is to return a scalar, Gain_{i,j}(q), representing the fraction of power radiated in the EMF spatial sector (i, j) for the downlink allocation of user q (wireless device 22).

For example, referring back to FIG. 10, in the case of two-dimensional M_{V}×M_{H}×2 array configuration (e.g., where ‘2’ may relate to polarization), in some embodiments of the present disclosure, an algorithm (e.g., performed by/controlled by processing circuitry 68 and/or one or more modules/controllers/etc. thereof) divides the two-dimensional azimuth-elevation spatial grid into several horizontal-vertical EMF sectors EMF spatial sector {(i, j)}_{i,j} where the index i corresponds to the azimuth dimension and the index j corresponds to the elevation dimension. Let M_{V}M_{H}×M_{V}M_{H} be defined as the matrix B containing the per-polarization DFT-based steering vectors as B=D_{H}⊗D_{V} where ⊗ denotes the Kronecker product, the matrices D_{H} and D_{V} are respectively the M_{H}×M_{H} and M_{V}×M_{V} discrete Fourier transform (DFT) matrices, and the (m, k)th element of the matrix D_{X} is given by

$${D}_{X} ( m , k ) = \frac{1}{\sqrt{{M}_{X}}} {e}^{j \frac{2 π mk}{{M}_{X}}} where m , k = 0 , … , {M}_{X} - 1$$

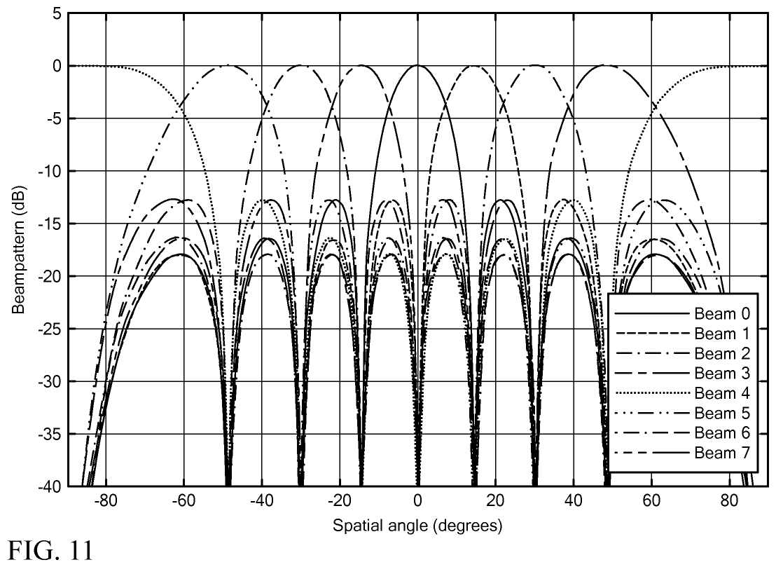

In some embodiments, each sector may be designed/configured such that it contains one or more two-dimensional spatial DFT beams and define the corresponding M_{V}M_{H}×N_{i,j} per-polarization beam vectors B_{i,j} where N_{i,j} is the number of DFT beams in the EMF sector (i, j). For example, in the case of a one-dimensional polarized array with M_{H}=8, M_{V}=1, FIG. 11 shows the one-dimensional spatial DFT beams corresponding to M_{H}=8 DFT beams. Note that since M_{V}=1, there may be only one sector in the elevation dimension. If there are four EMF sectors in the azimuth dimension, there may be an association of Sector 0 with Beam 0, Sector 1 with Beams 1 and 2, Sector 2 with beams 6 and 7, and Sector 3 with beams 3, 5, 7. In this case, the Beamspace basis matrix for Sector 0 is given by the 8×1 matrix B_{0,0} that contains column 0 of the 8×8 DFT (Discrete Fourier Transform) matrix corresponding to M_{H}=8. Similarly, the Beamspace basis for Sector 3 is given by the 8×3 matrix B_{3,0} that contains columns 3, 5, and 7 of the 8×8 DFT matrix.

For example, let W(q, f, t) denote 2M_{V}M_{H}×N_{L} precoding matrix used for transmission to user q (wireless device 22) on subband f at time t where N_{L}(q, t) is the number of layers allocated to user q (wireless device 22). This may be written as:

$$W ( q , f , t ) = [ \begin{matrix}{W}^{( 0 )} ( q , f , t ) \\ {W}^{( 1 )} ( q , f , t )\end{matrix} ]$$

where the M_{V}M_{H}×N_{L} (q, t) matrix W^{(p)}(q, f, t) is the precoding matrix for antenna elements with polarization p. For each EMF sector (i, j), with the corresponding per-polarization beam vectors matrix B_{i,j}, where N_{i,j} is the number of beams in the Sector (i, j), the processing circuitry 68 may compute the beamforming gain of the precoder associated with user q (wireless device 22) as in the EMF Sector (i, j) as

$${G}_{i , j} ( q , f , t ) = {\sum }_{k = 1}^{K} {\sum }_{p = 0}^{1} {‖ {{W}_{k}^{( p )} ( q , f , t )}^{T} {B}_{i , j} ‖}^{2}$$

where Wₖ^{(p)}(q, f, t) is the kth column of W^{(p)}(q, f, t) and

$$W ( q , f , t ) = [ \begin{matrix}{W}^{( 0 )} ( q , f , t ) \\ {W}^{( 1 )} ( q , f , t )\end{matrix} ] .$$

Note that the beamforming gain is normalized such that Σ_{i,j} G_{i,j}(q, f, t)=1 since all the DFT beams are mapped to the EMF sectors.

An advantage of using the DFT-based beamforming gain calculation method is that the beamforming gain is readily available in most cases independently of the array geometry. For example, for codebook-based precoding schemes the precoding matrices are known a priori and belong to a finite codebook and wideband precoding is usually used, i.e., the same beamforming vector is applied to all allocated subbands. Hence, for a given choice of the spatial controller directions, a look-up table can be constructed that maps each precoder to the corresponding average beamforming gain. On the other hand, for reciprocity-based precoding schemes, the beamforming weight computation is typically performed in Beamspace domain to allow for beam reduction, and hence, Wₖ^{(p)}(q, f, t)^{T}B_{i,j} are readily available when beamforming weights are computed. Therefore, for reciprocity-based schemes, only a small number of computations (magnitude computation and summation) may be required to compute the beamforming gain.

### Directional Power Calculator

The total momentary transmitted power at time t in the EMF spatial sector (i, j) can be estimated by collecting (e.g., at a network node 16) the allocated downlink power for each wireless device 22 and weighting this power by the average beamforming gain for this wireless device 22 in the direction (i, j), i.e.,

$${P}_{{tot}_{i , j}} ( t ) = {\sum }_{f} {\sum }_{q} {G}_{i , j} ( q , f , t ) p ( q , f , t )$$

where p(q, f, t) is the momentary power utilized at time t to transmit to user q (wireless device 22) on subband f, G_{i,j}(q, f, t) is the average beamforming gain for user q (wireless device 22) at transmission time t, the inner summation over q (wireless device 22) is performed over the users (wireless devices 22) that are scheduled on subband f at time t and the outer summation is performed over all frequency subbands utilized for downlink transmission at time t. One or more of these calculations may be implemented in/performed by/controlled by/etc. processing circuitry 68.

In addition to the power contributions from the downlink transmissions for different wireless devices 22, the power of other channels, e.g., control channels, should also be accounted for while calculating the total power. The directional power of the control channels is computed (e.g., by processing circuitry 68) by weighting the momentary control channel power by the average beamforming gain of the common control beam weights in the direction (i, j).

### Power Limit Calculation

Referring back to FIG. 9, the power limit calculation block (e.g., implemented in processing circuitry 68) is responsible for calculating the limit γ(q, f, t) for a scheduling request associated with user q (wireless device 22) when transmitting at time t on subband f. This limit may be utilized to control the power spectral density (power per resource block) when transmitting to user q (wireless device 22) as well as for link adaptation computations when calculating the MCS and TBS for user q (wireless device 22).

Embodiments of the present disclosure may utilize at least two different methods for computing γ̅(q, f, t), which computation may be performed by processing circuitry 68, for example. The first method is a wireless device 22—dependent limit method where the threshold is computed as

$$\overline{γ} ( q , f , t ) = {min}_{i , j} \frac{{\overline{γ}}_{i , j}}{{G}_{i , j} ( q , f , t )} ,$$

and hence, the effect of the beamforming gain of the wireless device 22 precoder is considered when the limit is calculated. The second method uses a low complexity WD-independent calculation of the threshold where the same threshold, corresponding to the spatial EMF sector with the max EMF limit and the precoder with max gain in this sector, is used for all WD 22s, i.e.,

$$\overline{γ} ( q , f , t ) = {min}_{i , j} {\overline{γ}}_{i , j}$$

As shown in FIG. 9, the power limit for each user q (wireless device 22) when transmitting at time t on subband f is provided to the scheduler to be considered during calculation (e.g., by processing circuitry 68) of the MCS and TBS when the downlink allocation request is being processed. Furthermore, this information is also included when calculating the momentary power utilized at time t to transmit to user q (wireless device 22) on subband f, i.e., p (q, f, t), to provide an accurate estimate of the momentary transmitted power at time t as explained herein.

### Bandwidth Limiting Fallback Algorithm

In some embodiments, computations (e.g., by processing circuitry 68) are performed in accordance an algorithm which utilizes the limit γ̅(q, f, t) to control the power spectral density (power per resource block) when transmitting to user q (wireless device 22) at time t on subband f. Reducing the power spectral density instead of reducing the downlink transmission bandwidth provides cell throughput gain when the user q (wireless device 22) has sufficiently high SINR. However, if the SINR of the user (wireless device 22) is low, the power per resource block is a more valuable resource for downlink scheduling than the bandwidth. In this case, reducing the power/PRB can lead to coverage problems and the user (wireless device 22) might drop out of coverage.

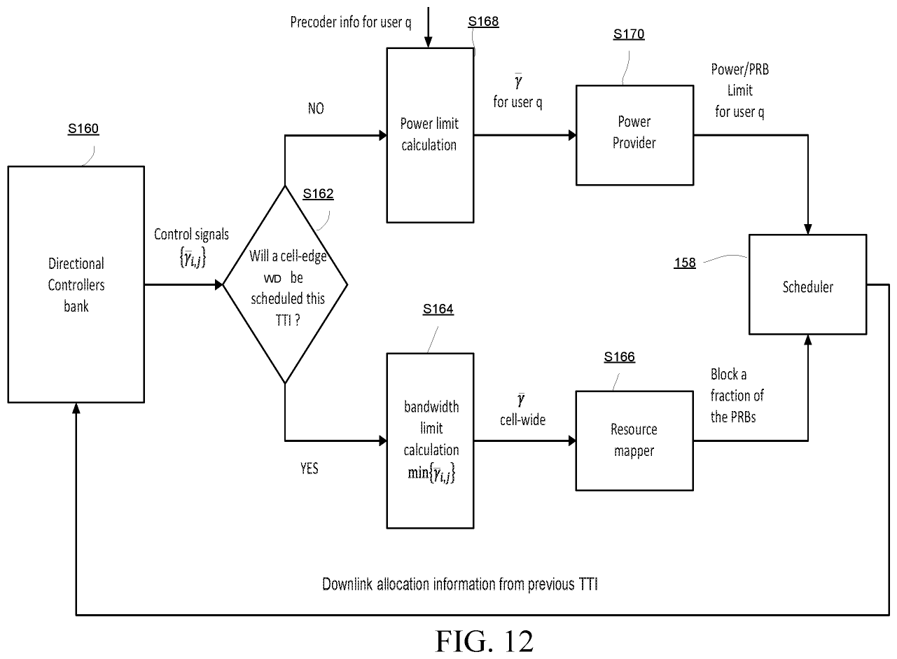

FIG. 12 illustrates an example block diagram of a fallback algorithm (e.g., as performed by processing circuitry 68) according to some embodiments of the present disclosure. The processing circuitry 68 may use the algorithm to determine whether a cell edge wireless device 22 is expected to be scheduled this TTI and uses a cell-wide bandwidth limit mechanism to enforce EMF constraints, else, the algorithm uses a wireless device-specific power/PRB mechanism to enforce EMF constraints.

Referring still to FIG. 12, at Block S158, the scheduler provides downlink allocation information from a previous TTI to directional controllers bank (Block S160). Directional controllers bank S160 determines control signals {γ̅_{i,j}}, which are used to determine (Block S162) whether a cell-edge WD 22 will be scheduled during this TTI. If Block S162 is ‘YES’, then the bandwidth limit calculation min {γ̅_{i,j}} is performed (Block S164), which generates a cell-wide threshold γ̅ for the resource mapper (Block S166), which blocks a fraction of the PRBs for scheduler (Block S158). If S162 is ‘NO’, then the power limit calculation is performed (Block S168) based on precoder info for user q (wireless device 22), which generates γ̅ for user q (wireless device 22) for power provider (Block S170), which provides power/PRB limit for user q (wireless device 22) to scheduler 158, and the process may be iteratively repeated.

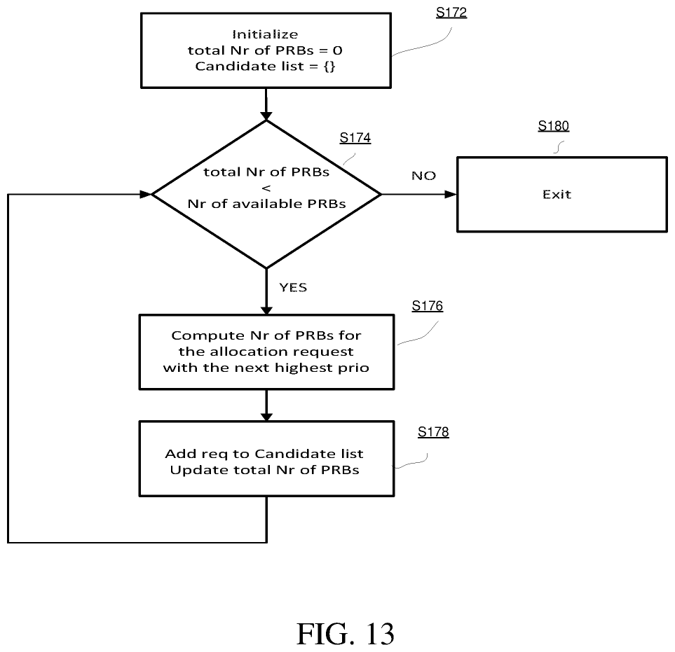

FIG. 13 shows an example block diagram of algorithm for determining the wireless devices 22 that are candidate for scheduling in the next TTI. In particular, the algorithm may be given by:

Initialize (Block S172): total number of PRBs=0, Candidate list is Empty

While total number of PRBs<number of available PRBs for downlink scheduling (Block S174):
Get the next allocation request with the highest priority (Block S176)
Estimate the number of PRBs for the allocation request by dividing the number of requested bits by the ICC per PRB for the request
Add allocation request to Candidate list (Block S178)
Increment total number of PRBs by number of PRBs for the allocation request

End while (Block S180)

After estimating the wireless devices 22 that are candidate for scheduling in the next TTI, the algorithm (e.g., as implemented by processing circuitry 68) according to some embodiments determines whether the list contains a cell-edge wireless device 22. In one embodiment of the algorithm according to embodiments of the present disclosure, the SINR is used to determine whether a wireless device 22 is cell-edge wireless device 22 or not.

For each allocation request in Candidate list:
Compute average SINR in dB as average channel gain to interference-plus-noise ratio (GINR) estimate in dB plus full power per subband in dB
If Average SINR<cell edge SINR threshold
Declare Cell edge WD 22 will be scheduled and Exit

End For

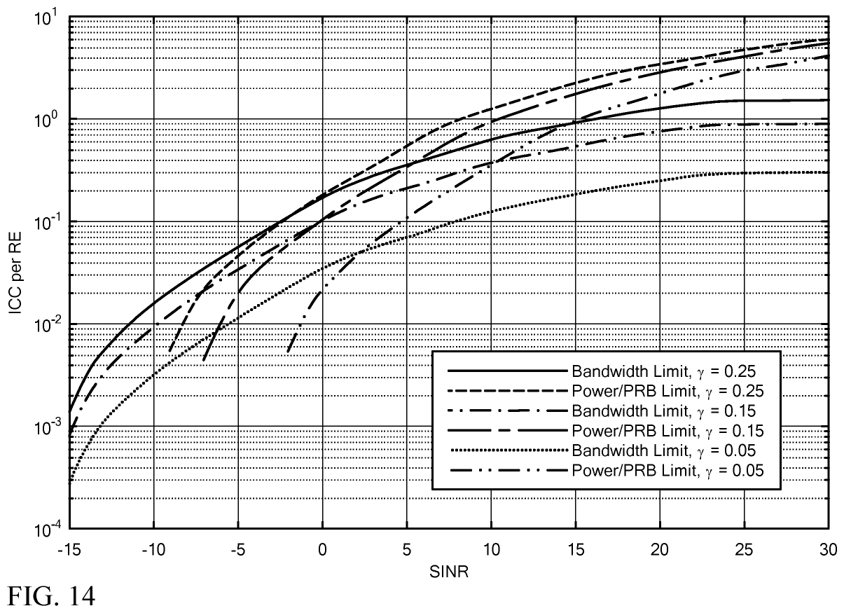

The cell-edge SINR threshold can be determined using the EMF controller threshold and the SINR to ICC mapping function. FIG. 14 shows the ICC per resource element (RE) versus SINR for different limiting solutions and EMF thresholds. Let γ denote the EMF limit. When Bandwidth limit is enforced; the ICC per RE is given by

f(x)=γICC(SINR)

On the other hand, when power per PRB limit is enforced, the ICC per RE is given by

f(x)=ICC(γSINR)

It can be seen from FIG. 14 that the cell-edge SINR threshold depends on the EMF limit. For example, for γ=0.25 bandwidth limit is optimal for SINR<−1 dB, while for γ=0.05, bandwidth limit is optimal for SINR<2.5 dB.

### Simulation Results

The performance of the directional EMF control algorithm of some embodiments disclosed herein is illustrated using system-level simulations. A 5G cellular system with bandwidth 100 MHz and carrier frequency 3.5 GHz is simulated. The system operates in time division duplex mode where the Downlink/Uplink timeslot pattern is 3/1. A single cell scenario with cell radius 166 meters is considered, where 12 WD 22s are dropped randomly in the simulation area. The 5G SCM Urban Macro channel model is used in this simulation. The antenna configuration at the base station is the 4×8×2 configuration (cross polarized antenna elements of 4 rows and 8 columns). The traffic model for the downlink is selected as full buffer.

SU-MIMO codebook precoding is utilized in downlink transmission using WD 22 reported CSI based on 32 port CSI-RS transmissions where each WD 22 can be assigned a maximum of 4 Layers. The averaging window length of the EMF control algorithm is selected as 6 seconds and the simulation duration is 36 seconds. Simulation results are averaged over 25 Monte Carlo runs where the WD 22s are randomly dropped in each simulation.

The azimuth dimension is divided into a configurable number of spatial EMF sectors. The EMF limit for sector 0 (boresight sector) is set to 15% while the remaining EMF spatial sectors (if the number of sectors is greater than 1) do not have any EMF limitations. For example, the performance of the algorithm according to embodiments of the present disclosure with WD-dependent power/PRB limit as well as WD-dependent power/PRB limit may be considered. The performance of the algorithm according to embodiments of the present disclosure may be compared against legacy algorithms employing cell-wide bandwidth limit and cell-wide power scale & bandwidth limit. In addition, the upper bound where no EMF limit is imposed on any spatial sector may be considered.

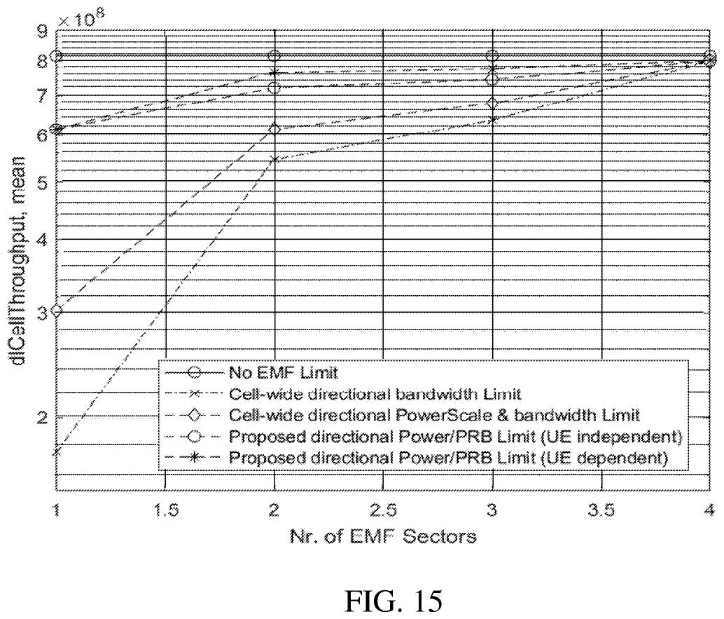

FIG. 15 shows the downlink cell 18 throughput versus the number of spatial EMF sectors. This figure illustrates some benefits, in accordance with embodiments of the present disclosure, of considering the spatial directivity of the downlink precoders when calculating the EMF limit as the downlink cell throughput increases for all EMF limit algorithms as the number of spatial EMF sectors increases. The advantage of using power/PRB limitation can also be seen from FIG. 15 where the performance of the algorithms according to embodiments of the present disclosure is shown to be superior to that of power scaling & bandwidth limitation which is superior to that of bandwidth only limitation. Furthermore, FIG. 15 illustrates an advantage of WD-dependent power/PRB limit over cell-wide WD-independent limit especially when the number of EMF spatial sectors is small where with WD-dependent limit, downlink transmissions to the WDs that are not located in sector 0 can still occur with full transmission power even though the EMF limit for sector 0 is triggered.

Next, performance of the fallback algorithm according to embodiments presented herein may be considered, for example, in the context of an example deployment scenario with one user (wireless device 22) that is placed 400 m away from the network node 16 at boresight direction. The EMF algorithm utilizes a single EMF sector, i.e., non-directional EMF control, with 15% EMF threshold. The SINR switching threshold was selected as 0 dB. In this simulation, the downlink interference level is changed to simulate different WD radio conditions.

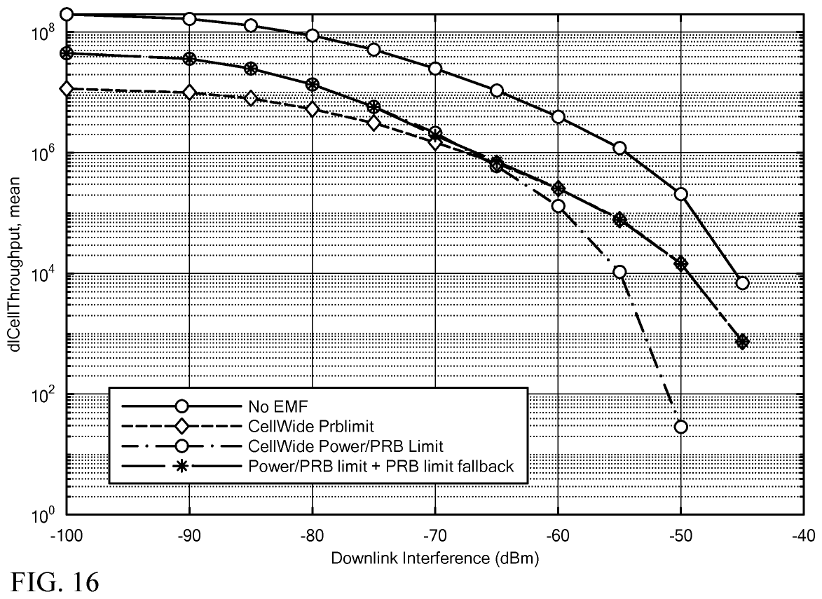

FIG. 16 shows the downlink cell throughput versus the downlink interference level where switching between Power/PRB and bandwidth limiting is based on the estimated SINR that can effectively utilize the available power and bandwidth resources yielding the highest throughput at different values of SINR.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| AAS | Advanced Antenna Systems |
| EMF | Electromagnetic Field |
| CSI | Channel State Information |
| CSI-RS | Channel State Information Reference Symbols |
| DFT | Discrete Fourier Transform |
| GINR | Gain to Interference-plus-Noise Ratio |
| ICC | Information Carrying Capacity |
| MCS | Modulation and Coding Scheme |
| NR | New Radio |
| PD | Proportional-Derivative |
| PDCCH | Physical Downlink Control Channel |
| PDSCH | Physical Downlink Shared Channel |
| PI | Proportional-Integral |
| PMI | Precoder matrix indicator |
| PRB | Physical Resource Block |
| RAT | Reciprocity-aided transmission |
| RI | Rank Indicator |
| RE | Resource Element |
| RF | Radio Frequency |
| SRS | Sounding Reference Symbol |
| TBS | Transport Block Size |
| UE | User Equipment |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a first wireless device in a cell, the network node comprising:
processing circuitry configured to:
estimate a first signal quality metric associated with the first wireless device;
determine a first directional electromagnetic field, EMF, limiting mechanism for transmission to the first wireless device based on the first signal quality metric, the first directional EMF limiting mechanism being different from another directional EMF limiting mechanism used for transmission to at least one other wireless device in the cell; and
cause transmission to the first wireless device using the first directional EMF limiting mechanism.

2. The network node of claim 1, wherein the processing circuitry is further configured to determine that the first wireless device is not located at an edge of the cell based on the estimated first signal quality metric; and
the determining of the first directional EMF limiting mechanism being further based on the determination that the first wireless device is not located at the edge of the cell, the first directional EMF limiting mechanism including a first power spectral density limit.

3. The network node of claim 2, wherein the processing circuitry is further configured to:
determine a second directional EMF limiting mechanism for a second wireless device in the cell based on the determination that the first wireless device is not located at the edge of the cell, the second directional EMF limiting mechanism including a second power spectral density limit used for transmission to the second wireless device different from the first power spectral density limit.

4. The network node of claim 1, wherein the processing circuitry is further configured to determine that a third wireless device is located at an edge of the cell based on an estimated third signal quality metric for the third wireless device; and
determine a third directional EMF limiting mechanism including a third limit on an available bandwidth during transmission to the third wireless device.

5. The network node of claim 1, wherein the first directional EMF limiting mechanism is one of:
a first power spectral density limit based on the first signal quality metric being above a first threshold; and
a first bandwidth limit based on the first signal quality metric being below the first threshold.

6. The network node of claim 1, wherein the first signal quality metric includes at least one of:
an information carrying capacity, ICC;
a signal to interference and noise ratio, SINR;
a signal to noise ratio, SNR;
a reference signal received power, RSRP;
a reference signal received quality, RSRQ; and
a received signal strength indicator, RSSI.

7. The network node of claim 1, wherein the processing circuitry is further configured to receive a first scheduling request from the first wireless device; and
the determining of the first directional EMF limiting mechanism being further based at least on the power spectral density and bandwidth required for serving the first scheduling request.

8. The network node of claim 7, wherein the processing circuitry is further configured to determine a first beamforming gain associated with a precoder used for transmission to the first wireless device based on the first signal quality metric and the first scheduling request; and
the determining of the first directional EMF limiting mechanism being further based on the first beamforming gain.

9. The network node of claim 7, wherein a first power spectral density limit is different from at least one other power spectral density limit of at least one other directional EMF limiting mechanism used for transmission to at least one other wireless device located in a second sector in the cell different from a first sector.

10. A method implemented in a network node configured to communicate with a first wireless device in a cell, the method comprising:
estimating a first signal quality metric associated with the first wireless device;
determining a first directional electromagnetic field, EMF, limiting mechanism for transmission to the first wireless device based on the first signal quality metric, the first directional EMF limiting mechanism being different from another directional EMF limiting mechanism used for transmission to at least one other wireless device in the cell; and
causing transmission to the first wireless device using the first directional EMF limiting mechanism.

11. The method of claim 10, further comprising determining that the first wireless device is not located at an edge of the cell based on the estimated first signal quality metric; and
the determining of the first directional EMF limiting mechanism being further based on the determination that the first wireless device is not located at the edge of the cell, the first directional EMF limiting mechanism including a first power spectral density limit.

12. The method of claim 11, further comprising:
determining a second directional EMF limiting mechanism for a second wireless device in the cell based on the determination that the first wireless device is not located at the edge of the cell, the second directional EMF limiting mechanism including a second power spectral density limit used for transmission to the second wireless device different from the first power spectral density limit.

13. The method of claim 10, further comprising determining that a third wireless device is located at an edge of the cell based on an estimated third signal quality metric for the third wireless device; and
determining a third directional EMF limiting mechanism including a third limit on an available bandwidth during transmission to the third wireless device.

14. The method of claim 10, wherein the first directional EMF limiting mechanism is one of:
a first power spectral density limit based on the first signal quality metric being above a first threshold; and
a first bandwidth limit based on the first signal quality metric being below the first threshold.

15. The method of claim 10, wherein the first signal quality metric includes at least one of:
an information carrying capacity, ICC;
a signal to interference and noise ratio, SINR;
a signal to noise ratio, SNR;
a reference signal received power, RSRP;
a reference signal received quality, RSRQ; and
a received signal strength indicator, RSSI.

16. The method of claim 10, further comprising receiving a first scheduling request from the first wireless device; and
the determining of the first directional EMF limiting mechanism being further based at least on the power spectral density and bandwidth required for serving the first scheduling request.

17. The method of claim 16, further comprising determining a first beamforming gain associated with a precoder used for transmission to the first wireless device based on the first signal quality metric and the first scheduling request; and
the determining of the first directional EMF limiting mechanism being further based on the first beamforming gain.

18. The method of claim 16, wherein a first power spectral density limit is different from at least one other power spectral density limit of at least one other directional EMF limiting mechanism used for transmission to at least one other wireless device located in a second sector in the cell different from a first sector.

19. A non-transitory computer readable storage medium storing a computer program comprising instructions causing processing circuitry to at least one of control and perform a method, the method comprising:
estimating a first signal quality metric associated with a first wireless device;
determining a first directional electromagnetic field, EMF, limiting mechanism for transmission to the first wireless device based on the first signal quality metric, the first directional EMF limiting mechanism being different from another directional EMF limiting mechanism used for transmission to at least one other wireless device in a cell; and
causing transmission to the first wireless device using the first directional EMF limiting mechanism.

20. The non-transitory computer readable storage medium of claim 19, wherein the method further comprises determining that the first wireless device is not located at an edge of the cell based on the estimated first signal quality metric; and
the determining of the first directional EMF limiting mechanism being further based on the determination that the first wireless device is not located at the edge of the cell, the first directional EMF limiting mechanism including a first power spectral density limit.
